(19) United States
(12) Patent Application Publication
(10) Pub. No.: US 2006/0039672 A1
(43) Pub. Date: Feb. 23, 2006

(54) Tape reproducing apparatus

(75) Inventors: Masaki Yamada, Kanagawa (JP); Takumi Sugaya, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/194,535

(22) Filed: Aug. 2, 2005

(30) Foreign Application Priority Data
Aug. 23, 2004 (JP) 2004-242603

(51) Int. Cl. H04N 5/76

(52) U.S. Cl. 386/46; 386/95

(57) ABSTRACT

A tape reproducing apparatus has an arrangement in which if a read error occurs when a magnetic tape in which meta-data, still picture data and moving picture data are recorded is read and the kind of data such as meta-data, still picture data and moving picture is judged (steps ST14, ST19 and ST23) based on the searched state or the continuously reproducing state, whereby it is determined (steps ST11, ST16, ST20 and ST25) that retrying is made if the retrying number is less than the predetermined retrying upper limit number set in each of kind of data and that retrying is not made if the retrying number is greater than the predetermined retrying upper limit number.

### CROSS REFERENCES TO RELATED APPLICATIONS

The present invention contains subject matter related to Japanese Patent Application JP 2004-242603 filed in the Japanese Patent Office on Aug. 23, 2004, the entire contents of which being incorporated herein by reference.

### BACKGROUND OF THE INVENTION

1. Field of the Invention

The present invention relates generally to a tape reproducing apparatus for reproducing digital data, and particularly to tape reproducing technology suitable for reproducing digital data such as moving picture data by using a tape streamer.

2. Description of the Related Art

As a tape recording and reproducing apparatus for recording digital data on a magnetic tape and reproducing digital data from the magnetic tape, it has been customary to use a tape recording and reproducing apparatus of a helical scan system in which data can be recorded on and reproduced from a magnetic tape wrapped around a cylindrical drum with magnetic heads mounted thereon while the cylindrical drum is being rotated. One of tape streamers using this tape recording and reproducing apparatus to retain digital data of a large data amount at high reliability makes effective use of the standards of an 8-mm tape cassette having a vehement storage capacity of approximately several 10 s of gigabytes to 100 gigabytes at present, for example. Therefore, in addition to use of retaining data for backup of data recorded on a hard disk connected to a computer apparatus, such tape streamer can be used to retain data such as image data whose data size is large and hence the tape streamer is frequently used to backup or archive data.

Since reliability of the above-mentioned data is regarded as most important, it is customary to error-correct such data when a magnetic tape is reproduced. However, it is frequently observed that errors, which may not be error-corrected, will occur in the thus read data. In such case, the magnetic tape is rewound and the same portion is read again so that correct data can be obtained. In the case of the tape streamer, reliability of retained data is important and hence the same portion is reread a plurality of times repeatedly until correct data can be obtained. Processing for obtaining correct data by rereading the same portion of the magnetic tape when an uncorrectable error occurs in the magnetic tape is referred to as “rereading (retrying)”. If the same portion of the magnetic tape is reread, then a possibility in which data will be read correctly can be increased. In the case of the tape streamer, since it is requested that data should be high in reliability, processing in which the kind of data is discriminated to limit the number of rereading (retrying) has never been made so far.

Cited Patent Reference 1 describes a tape streamer in which rereading (retrying) is repeated the predetermined number of times when a read error occurs due to a height difference produced in a magnetic tape wound around a rotary drum if the magnetic tape is wound around the rotary drum in the different state from the prescribed layout.

Cited Patent Reference 1: Official Gazette of Japanese laid-open patent application No. 2000-348319 (FIG. 14)

The tape streamer is a data recording system of a large storage capacity and hence it is able to record moving picture data of a large data amount such as motion picture data. When moving picture data recorded by the data recording system of the tape streamer is reproduced, if a read error occurs in the image data, transfer of image data is delayed by retrying so that reproduction of image is interrupted, thereby resulting in the continuity of the moving picture being interrupted.

However, when the magnetic tape is used as a media for reproducing moving pictures, since slight disorder of the moving picture may be neglected, continuity of the moving picture may be regarded as more important. That is, since it is not requested that all read data should be reproduced accurately with a lot of time, even when a read error occurs, it is necessary to limit the number of retrying to some extent.

Not only moving picture data but also meta-data, which describes information concerning data, is recorded on the magnetic tape. In this case, when important meta-data may not be read, there is a possibility that such error will lead to a fatal error in which other data will not be read. Thus, it is necessary to reliably read meta-data by executing retrying many times. Also, thumbnails and the like are recorded on the magnetic tape as still picture data relative to the moving picture data. Even when still picture data may not be read, such read error will not lead to a fatal error. Also, continuity of still picture data need not be considered strictly unlike the case in which moving picture data is read. Hence, while it is sufficient that the still picture data may be retried a certain number of times, the moving picture data may be retried the number of times to the extent that continuity of reproduction may not be interrupted.

### SUMMARY OF THE INVENTION

In view of the aforesaid aspects, the present invention intends to provide a tape reproducing apparatus in which data such as moving picture data recorded by using a tape streamer can be reproduced satisfactorily.

According to an aspect of the present invention, there is provided a tape reproducing apparatus for reproducing a magnetic tape in which each recorded content is divided into a plurality of partition units, the partition is divided into a plurality of section units at every meta-data, still picture data and moving picture data, file marks indicative of ends of sections are assigned to the sections each, a file mark count obtained by accumulatively adding the file marks at every section being recorded. This tape reproducing apparatus is composed of a data read unit for reading the magnetic tape, a data discriminating unit for discriminating the kind of meta-data, still picture data and moving picture data by using the file mark count obtained by reading the magnetic tape with the data read unit and a control unit for controlling retrying processing to read the same portion of the magnetic tape by the data read unit if data read by the data read unit may not be error-corrected and setting the upper limit number of retrying processing to read the same portion of the magnetic tape at every kind of meta-data, still picture data and moving picture data discriminated by the data discriminating unit.

According to this arrangement, when the magnetic tape is reproduced, it becomes possible to discriminate the kind of data by using the file mark count.

According to the present invention, since the kind of data can be discriminated and read, it is possible to control the retrying number in response to the kind of data. For example, it is possible to smoothly carry out retrying corresponding to the object of data reproduction by effecting control on the retrying in such a manner that important meta-data should be retried many times, still picture data, which is not limited from a time standpoint, should be retried a certain number of times and that moving picture data of which continuity is regarded as important should be retried a few times.

Also, if the retrying number of the meta-data is set to be greater than the retrying number of the still picture data which is not so much limited from a time standpoint and the retrying number of the moving picture data of which continuity is regarded as important, then there can be achieved an effect in which important information can be obtained reliably when data is reproduced.

Further, even if a read error occurs when data greater than the reference value is accumulated in the buffer memory during a moving picture is being reproduced, then retrying of the moving picture data can be carried out without interrupting the continuity of the moving picture. Also, even when data less than the reference value are accumulated in the buffer memory, it is possible to reliably reproduce data by retrying the data within the predetermined retrying number of times.

Furthermore, if a standby time of a constant duration is provided after the section of the still picture data or the moving picture data was searched and retrying within the predetermined number is carried out, reproduced data can be accumulated in the empty buffer memory so that the moving picture can be reproduced smoothly. Also, even when a read error occurs, the moving picture data can be retried without interrupting the continuity of the moving picture.

### BRIEF DESCRIPTION OF THE DRAWINGS

FIG. 1 is a block diagram showing an example of an arrangement of a tape reproducing apparatus according to an embodiment of the present invention;

FIG. 2 is a block diagram showing an example of an arrangement of a tape unit according to an embodiment of the present invention;

FIG. 3 is a block diagram showing an example of an arrangement of a motherboard according to an embodiment of the present invention;

FIG. 4 is a schematic diagram showing an example of an arrangement of the inside of a tape cassette according to an embodiment of the present invention;

FIG. 5 is a perspective view showing an example of an arrangement of the outside of the tape cassette according to an embodiment of the present invention;

FIGS. 6A to 6C are explanatory diagrams showing data structures of memory areas in the AIT (Advanced Intelligent Tape) format according to an embodiment of the present invention, respectively;

FIG. 7 is an explanatory diagram showing an example of the groups to be read upon search according to an embodiment of the present invention; and

FIG. 8 is a flowchart to which reference will be made in explaining a retrying control procedure according to an embodiment of the present invention.

### DESCRIPTION OF THE PREFERRED EMBODIMENTS

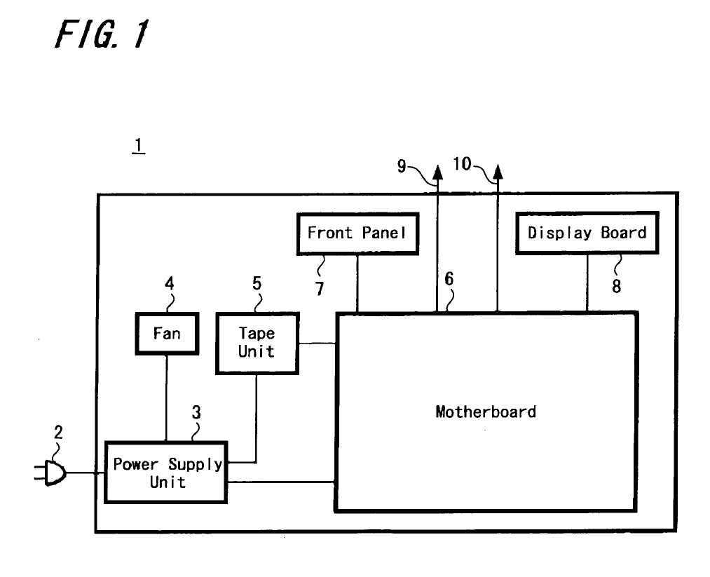

A tape reproducing apparatus according to an embodiment of the present invention will hereinafter be described with reference to FIGS. 1 to 8. This embodiment will describe an example in which a tape streamer capable of storing a vehement amount of moving picture data highly reliably is used as a tape reproducing apparatus to read data recorded in a tape cassette, images being displayed on a display monitor and sounds being outputted from a speaker. Image data is converted in an MPEG2 (Moving Picture Experts Group Phase2) format, encrypted and recorded on a magnetic tape. In the following explanation, text, still picture, moving picture, music, sound and expressions of information of combinations of text, still picture, moving picture, music and sound will be referred to as “contents”. Also, processing for obtaining correct data by reproducing the same portion of a magnetic tape one more time if an uncorrectable error occurs in reproduced data during the magnetic tape is being reproduced will be referred to as “retrying”.

FIG. 1 of the accompanying drawings is a block diagram showing an example of an arrangement of a tape reproducing apparatus 1 according to an embodiment of the present invention. In this case, the tape reproducing apparatus 1 is a tape reproducing apparatus exclusively designed to read data from a tape cassette in which moving picture data and still picture data are retained as digital data and which then outputs images and sounds of the thus read data to external equipment.

As shown in FIG. 1, a plug 2 connected to an AC (Alternating Current) power supply is located outside the tape reproducing apparatus 1 and the tape reproducing apparatus 1 includes therein a power supply unit 3 to convert an AC voltage to a DC (Direct Current) voltage and the power supply unit 3 supplies the DC voltage to respective devices located within the tape reproducing apparatus 1. Power is supplied from the plug 2 to the power supply unit 3. Then, the power supply unit 3 supplies a predetermined DC voltage to a fan 4 to cool the inside of the tape reproducing apparatus 1 with air, a tape unit 5 to read data from a magnetic tape (not shown) and a motherboard 6 to control operations of the tape unit 5 to decode the read data to provide a video signal and an audio signal.

A display board 8 having a function to display the operating situations of the tape reproducing apparatus 1 includes a light-receiving device for receiving a control signal from a remote controller located in the outside, although not shown. Also, the display board 8 is provided with a parallel interface to supply a control signal to the motherboard 6. The tape reproducing apparatus 1 has a front panel 7 with operation keys mounted thereon to supply control signals to the motherboard 6. Then, the tape reproducing apparatus 1 may be operated under control of key operations of the remote controller and key operations of the keys on the front panel 7. Under control of the key operations of the remote controller, the control signals are transmitted to the motherboard 6 through the light-receiving device within the display board 8 in a wireless fashion such as infrared communication. Alternatively, under control of the key operations of the keys on the front panel 7, the control signals can be transmitted to the motherboard 6, whereby operations of the tape reproducing apparatus 1 can be controlled.

A tape cassette 100, which will be described later on, is loaded onto the tape unit 5 and thereby data is read out from the tape cassette 100. Image data and audio data read out from the tape cassette 100 are supplied to the motherboard 6, decoded and then outputted through an image cable 9, which transmits a video signal, and an analog audio cable 10, which transmits an audio signal, to a display monitor and a speaker, not shown, by which a user can view reproduced images and can listen to reproduced sounds. The tape unit 5 is provided with an interface conforming to the SCSI (Small Computer System Interface) and hence control signals are transmitted and received between the tape unit 5 and the motherboard 6 in a two-way communication fashion.

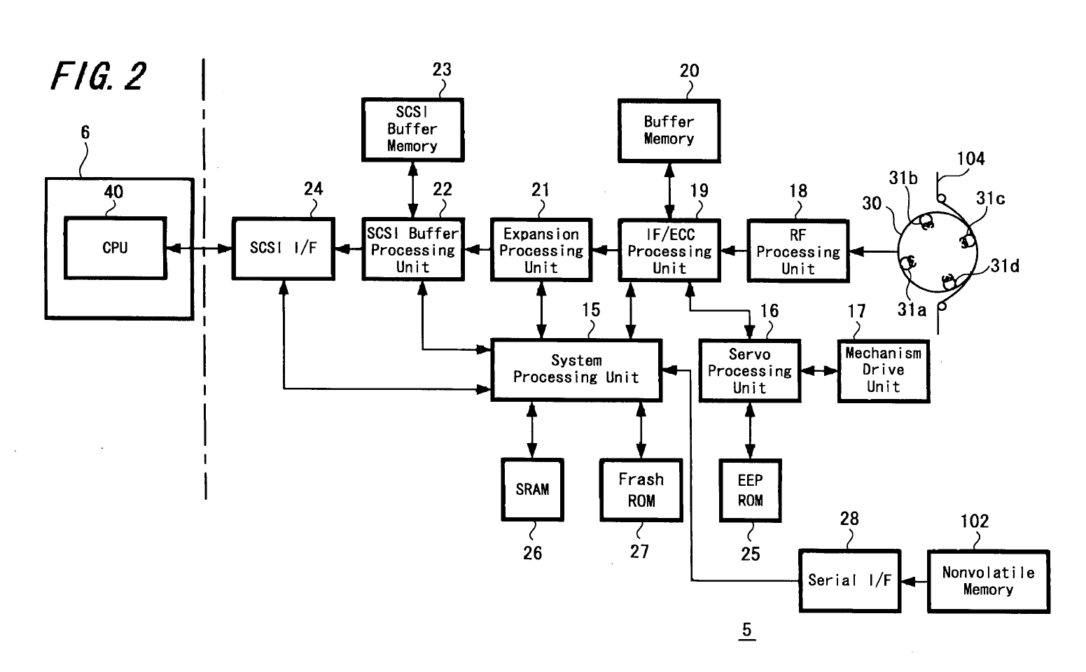

Next, an example of an arrangement of the tape unit 5 will be described with reference to a block diagram of FIG. 2.

As shown in FIG. 2, the tape unit 5 has a function in which data is read out from a magnetic tape 104 within a tape cassette 100 loaded onto the tape reproducing apparatus 1 by a helical scan system rotary magnetic head, data is decoded, a video signal and an audio signal being transmitted to a CPU (Central Processing Unit) 40, which will be described later on. An arrangement of the tape cassette 100 and a data structure of data recorded on the magnetic tape 104 will be described later on. The tape cassette 100 according to this embodiment has a built-in nonvolatile memory 102 in which there are recorded a date and place of each tape cassette was produced, a tape thickness, a tape length and a tape material, information concerning a history in which recorded data is used at every divided unit and user information and the like, the above information and the user information being recorded on the magnetic tape 104. A variety of information recorded on the nonvolatile memory 102 will be referred to as “management information”.

Then, the tape unit 5 has a function to read the management information from the magnetic tape 104. A rotary drum 30 around which the magnetic tape 104 is wound has four reproducing heads 31a to 31d having a predetermined azimuth angle mounted thereon at an angle of 90 degrees to read data from the magnetic tape 104 as RF (Radio Frequency) reproduced signals. When the tape cassette 100 is loaded onto the tape unit 5, the magnetic tape 104 is wound around the rotary drum 30 by a loading motor (not shown). The magnetic tape 104 is transported in the forward direction or the reverse direction by reel hubs 101a and 101b, which will be described later on, and RF reproducing signals are read out from the magnetic tape 104 by the reproducing heads 31a to 31d mounted on the rotary drum 30.

Then, the RF reproduced signals read out from the magnetic tape 104 by the reproducing heads 31a to 31d are supplied to an RF processing unit 18 which executes processing such as playback equalizing, generation of playback clock, binarization and decoding (Viterbi decoding). The RF reproduced signal processed by the RF processing unit 18 is supplied to an IF/ECC (Interface/Error Check and Correct) processing unit 19 which executes signal error detection or ECC error-correction processing at every group and the like. The IF/ECC processing unit 19 is connected to a buffer memory 20 to temporarily accumulate therein resultant data obtained after processing. The buffer memory 20 is formed of a DRAM (Dynamic Random-Access Memory) and an amount of data to be stored is set in consideration of suitable factors such as a data transfer rate. A predetermined data amount of reproduced data error-checked and error-corrected by the IF/ECC processing unit 19 is accumulated in the buffer memory 20.

The data accumulated in the buffer memory 20 is supplied through the IF/ECC processing unit 19 to an expansion processing unit 21 which expands compressed recorded data. If reproduced data is compressed data, then such compressed reproduced data is expanded. If on the other hand reproduced data is not compressed data, then such reproduced data is not expanded and thereby bypassed. Then, a SCSI buffer processing unit 22 is adapted to control transfer of data to a SCSI interface 24, and the SCSI buffer processing unit 22 is connected to a SCSI buffer memory 23 to temporarily accumulate processed data in order to obtain the transfer rate of the SCSI interface 24. A predetermined data amount of the reproduced data supplied from the expansion processing unit 21 is stored in the SCSI buffer memory 23 through the SCSI buffer processing unit 22. After that, reproduced data is supplied from the SCSI buffer memory 23 through the buffer processing unit 22 to the SCSI interface 24.

Then, the CPU (Central Processing Unit) 40 which interprets and executes program commands at the fixed length record unit is located on the motherboard 6. Further, the SCSI interface 24 is connected to the SCSI buffer processing unit 22 to thereby transmit and receive data between the tape unit 5 and the CPU 40 in a two-way communication fashion.

The servo processing unit 16 to control revolution rates of motors built in the tape unit 5 and the system processing unit 15 to execute control processing of the whole of the tape unit 5 are connected to each other through the IF/ECC processing unit 19 in a two-way communication fashion. The servo processing unit 16 has an arrangement to supply rotational speed signals to a mechanism drive unit 17 which drives respective motors. Motors, not shown, are connected to the mechanism drive unit 17. Motors driven by the mechanism drive unit 17 may be a drum motor to rotate the rotary drum 30, a capstan motor to transport the magnetic tape 104 at a constant speed, reel motors to rotate the reel hubs 101a and 101b in the forward direction or the reverse direction, a loading motor to insert and eject (load and unload) the magnetic tape into and from the tape cassette 100, an eject motor to insert and eject the tape cassette 100 into and from the tape reproducing apparatus 1 and so forth. Further, an EEPROM (Electrically Erasable Programmable Read-Only Memory) 25 to store therein constants for use in servo-controlling respective motors and so forth is connected to the servo processing unit 16.

All control operations of the tape unit 5 may be executed based on control signals from the CPU 40. Control signals from the CPU 40 are supplied through the SCSI interface 24 to the system processing unit 15. The system processing unit 15 is connected to the SCSI interface 24, the SCSI buffer processing unit 22, the expansion processing unit 21, the IF/ECC processing unit 19 and a serial interface 28 which the nonvolatile memory 102 conforms to in a two-way communication fashion thereby to read the magnetic tape 104. A SRAM (static-RAM) 26 and a flash ROM 27 in which data used in various processing in the system processing unit 15 are stored are respectively connected to the system processing unit 15 and thereby data can be read. The SRAM 26 may be used as a RAM for a work area and as a memory to store data read out from the nonvolatile memory 102, data set at the tape cassette unit and various flag data. Also, this SRAM 26 may be used to execute calculation processing. Then, the flash ROM 27 is a memory to store therein constants for use in controlling the system processing unit 15 and so forth. Further, the nonvolatile memory 102 is connected through the serial interface 28 to the system processing unit 15 to supply information such as address information of the magnetic tape 104. Also, the system processing unit 15 controls the servo processing unit 16 and drives various kinds of motors through the mechanism drive unit 17.

When the tape cassette 100 is loaded onto the tape unit 5, the nonvolatile memory 102 may communicate with the system processing unit 15 through the serial interface 28 by using terminal pins 109a to 109e, which will be described later on, as output portions. Thus, the system processing unit 15 becomes able to read management information from the nonvolatile memory 102. Then, the nonvolatile memory 102 and the CPU 40 transmit information therebetween by using SCSI commands. Therefore, in particular, an exclusive-line need not be provided between the nonvolatile memory 102 and the CPU 40 with the result that data is transmitted and received between the tape cassette 100 and the CPU 40 only through the SCSI interface 24.

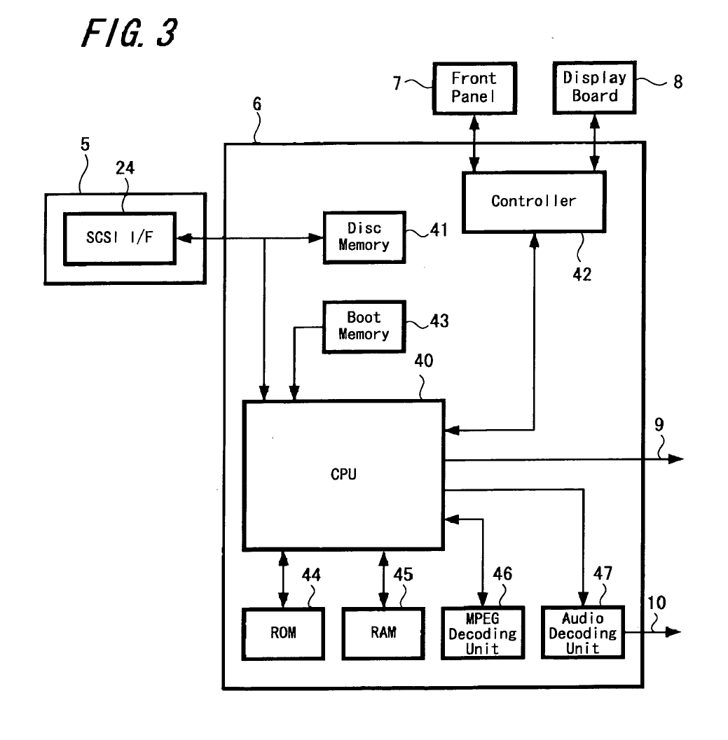

Next, an example of an arrangement of the motherboard 6 will be described with reference to a block diagram of FIG. 3. The motherboard 6 might be a printed circuit board (PCB) composed of various kinds of devices such as the CPU 40. As shown in FIG. 3, a disc memory 41, a controller 42, a boot memory 43, a ROM 44, a RAM 45, an MPEG decoding unit 46 and an audio decoding unit 47, which will be described later on, are provided as peripheral devices and the above-described respective peripheral devices are able to communicate with the CPU 40.

The CPU 40 is a main processor to control the whole of the tape reproducing apparatus 1, and the disc memory 41 has recorded thereon an OS (operating system) activated after a BIOS (Basic Input/Output System) was set and application programs to control the tape reproducing apparatus 1. This disc memory 41 is provided with an interface conforming to an IDE (Integrated Device Electronics) and it is connected to the CPU 40 through an IDE bus. Also, the CPU 40 has an arrangement to communicate with the SCSI interface 24 within the tape unit 5 in a two-way communication fashion.

The boot memory 43 has recorded thereon a boot program read out first when the tape reproducing apparatus 1 is energized to activate the tape reproducing apparatus 1 and the BIOS. The boot memory 43 is provided with an interface conforming to an ISA (Industry Standard Architecture) and it is connected to the CPU 40 through an ISA bus.

The motherboard 6 includes the controller 42 to control the tape reproducing apparatus 1 in response to signals supplied from the display board 8, that is, key operations from the remote controller and key operations from the front panel 7. The controller 42 may be composed of a processor (not shown) independently of the CPU 40 in order to control ON and OFF of the power supply switch of the tape reproducing apparatus 1 with power supply keys of the remote controller. Power necessary for driving the controller 42 may be supplied from a standby power supply source which can supply power to the controller 42 even when the power of the tape reproducing apparatus 1 is removed. This controller 42 is provided with an interface and it is connected to the CPU 40 in accordance with an RS-232C standard, for example.

The ROM 44 in which data that should not be lost when power is removed is recorded is composed of an EEPROM. Then, a RAM 45 is composed of a DIMM (Dual In-Line Memory Modules), for example.

When the tape reproducing apparatus 1 is energized, the tape reproducing apparatus 1 is energized through the controller 42 by the key operations made by the remote controller through the display keyboard 8 or the key operations done on the front panel 7. Then, the boot memory 43 is read and the program is activated, whereby the BIOS is set and the OS is activated. After that, the disc memory 41 is read and the OS and the application programs of the tape reproducing apparatus 1 are executed. During the CPU 40 is being driven, data such as constants necessary for processing are obtained from the ROM 44. Also, the RAM 45 may be used as a memory for a work area of programs or it may be used to retain chapter pictures of the magnetic tape 104 and the like.

Image data and audio data obtained from the magnetic tape 104 by the tape unit 5 are supplied through the SCSI interface 24 to the CPU 40. Because the image data is formed of the MPEG2 format, it is supplied to the MPEG decoding unit 46, in which it is decoded and transmitted to the CPU 40, from which it is transmitted to a display monitor (not shown) and thereby an image is displayed on this display monitor. A video signal obtained at that time may be a composite signal or a YUV component signal or an S-video signal. On the other hand, the audio data is supplied to the audio decoding unit 47, in which it is decoded and an analog audio signal is transmitted from the analog audio cable 10 to a speaker (not shown) and thereby sounds are outputted from the speaker.

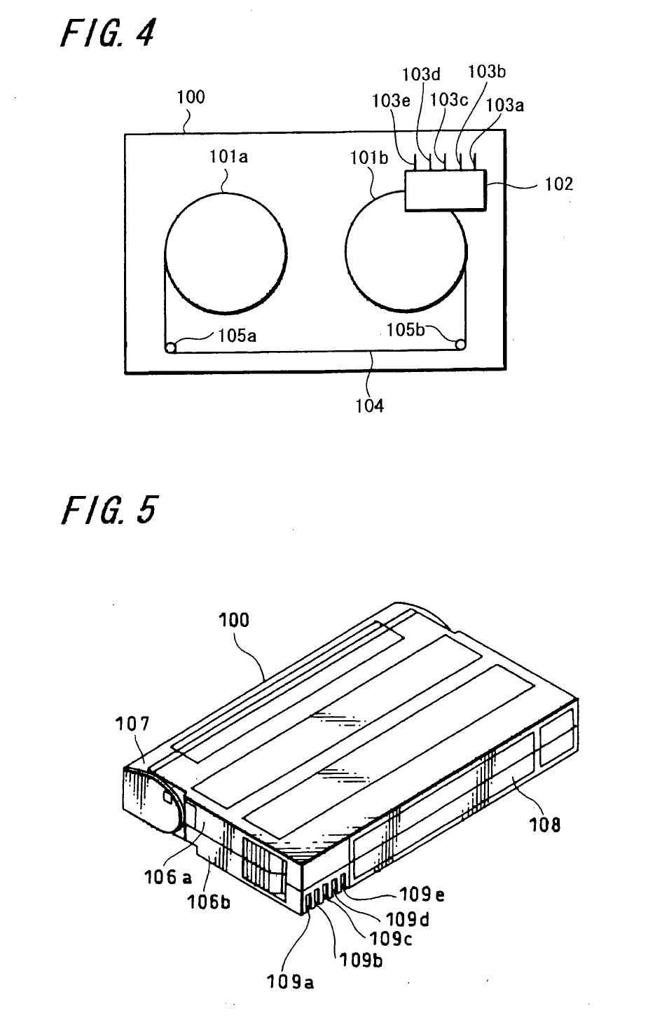

Next, an example of an arrangement of the inside of the tape cassette 100 loaded onto the tape reproducing apparatus 1 according to this embodiment will be described with reference to FIG. 4. As shown in FIG. 4, the reel hubs 101a and 101b for winding the magnetic tape 104 having a tape width of 8 mm are provided in the inside of the tape cassette 100 for use with the tape unit 5 according to this embodiment. Then, the magnetic tape 104 is supported with tension by rollers 105a and 105b. Also, this tape cassette 100 is provided with the nonvolatile memory 102. The module of this nonvolatile memory 102 includes five terminals 103a to 103e which are respectively constructed as a power supply terminal, a data input terminal, a clock input terminal, a ground terminal and a reserve terminal.

Next, an example of an arrangement of the outside of the tape cassette 100 loaded onto the tape reproducing apparatus 1 according to this embodiment will be described with reference to FIG. 5. FIG. 5 is a perspective view showing an example of an outside appearance of the tape cassette 100 according to this embodiment. As shown in FIG. 5, the whole casing of the tape cassette 100 is composed of an upper case 106a, a lower case 106b and a guard panel 107 to protect the surface of the magnetic tape. The overall arrangement of this casing of the tape cassette 100 is fundamentally similar to that of the arrangement for use with an ordinary 8-mm video tape cassette. The tape cassette 100 has on its side surface provided a label surface 108 to which a title label or the like is attached. This label surface 108 is provided with terminal pins 109a to 109e which are connected with the aforementioned terminals 103a to 103e in pairs. That is, the tape cassette 100 and the tape unit 5 may be brought in physical contact with each other through the terminal pins 109a to 109e to transmit a data signal and the like.

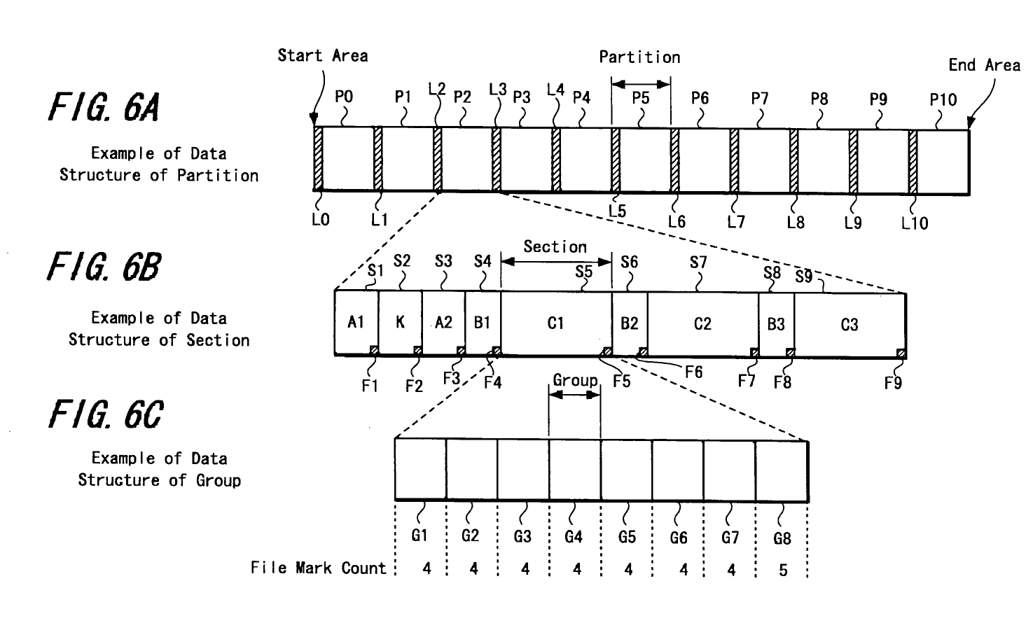

Next, examples of data structures of memory areas recorded on the magnetic tape 104 will be described with reference to FIGS. 6A to 6C. Although there exist a plurality of data formats concerning data recorded on and reproduced from the magnetic tape 104, an AIT (Advanced Intelligent Tape) format is used in this embodiment. FIG. 6A shows an example of a data structure obtained when one magnetic tape 104 is divided into a plurality of portions at the unit of so-called partitions. FIG. 6B shows an example of a data structure obtained when one of the aforementioned partitions is used as an example, the partition being divided into a plurality of portions at the unit of sections. FIG. 6C shows an example of a data structure obtained when one of the aforementioned sections is used as an example, the section being divided into a plurality of portions at the unit of groups.

First, the data structure of the partitions recorded on the magnetic tape 104 will be described with reference to FIG. 6A which shows the example of the data structure of the partitions. As shown in FIG. 6A, the magnetic tape 104 is divided into a plurality of partitions P0 to P10 as data recording areas. These partitions are composed of system areas to record thereon data similar to that in the nonvolatile memory 102 in which the management information is recorded and data areas in which data is written in actual practice, which will be described more in detail later on. The recording area of the magnetic tape 104 can be divided into 11 recording areas at maximum by using the partitions and it is possible to arbitrarily increase or decrease the length of the partition depending on the setting of an application recorded on the magnetic tape 104. However, only A1 and K areas, which will be described later on, can be recorded on the last partition.

Then, in order to protect the magnetic tape 104 from being damaged when the tape cassette 100 is inserted into and ejected from (loaded into and unloaded from) the tape reproducing apparatus 1, the partitions P0 to P10 have load and unload areas L0 to L10 maintained at their starting portions. The load and unload areas L0 to L10 are those to enable the tape cassette 100 to be stopped when the tape cassette 100 is unloaded from the tape reproducing apparatus 1. More specifically, in a tape reproducing apparatus such as an ordinary VCR (Video Cassette Recorder), when the tape cassette is unloaded from the tape reproducing apparatus after the tape cassette has been reproduced, the tape cassette can be unloaded from the tape reproducing apparatus at the position in which reproduction of the magnetic tape was stopped. Thus, next time the tape cassette is loaded onto the tape reproducing apparatus, a user is able to start viewing a continuance of reproduced data at the position in which the playback of the magnetic tape was stopped.

On the other hand, since the magnetic tape 104 of this embodiment has 11 partitions of P0 to P10 at maximum, the playback of the tape cassette 100 may be stopped at the load and unload areas L0 to L10 provided at the starting portions of the 11 partitions P0 to P10 and the tape cassette 100 may be loaded onto and unloaded from the tape reproducing apparatus 1. According to this arrangement, it is possible to prevent the tape cassette 100 from being loaded onto and unloaded from the tape reproducing apparatus 1 in the state in which the tape cassette 100 is stopped at the area in which data was recorded.

Although contents such as video data are recorded on the partitions P0 to P9, contents may not be recorded on the last partition P10 of the magnetic tape 104. The reason for this is to enable the tape cassette 100 to be loaded onto and unloaded from the tape reproducing apparatus 1 even at the end of the magnetic tape 104. However, this partition P10 is not limited thereto and it may be opened to a user so that the user can freely record data other than contents on this partition P10.

Next, the data structure of the sections will be described with reference to the example of the data structure of the sections shown in FIG. 6B. Although it is customary that video data of single contents may be recorded at every partition, if there are many contents, then it is possible to record a plurality of contents on one partition. From the example of the data structure of the partitions shown in FIG. 6A, it is to be understood that three contents are recorded on one partition, for example, the partition P2.

As shown in FIG. 6B, each partition has on its starting portion provided a section S1 in which the same data as that of the nonvolatile memory 102 shown in FIG. 4 is recorded. This section S1 is called an “A1 area”. While the nonvolatile memory 102 is able to read data through the terminal pins 109a to 109e on the tape cassette 100, there is a possibility that management information will not be read due to causes such as contact failures of contacts. Therefore, management information of the nonvolatile memory 102 is also recorded on the starting section of each section of the magnetic tape 104 so as to be backed-up. Then, according to this AIT format, since recorded video data is encrypted, a section S2 in which a decoding key to decode the thus encrypted data is recorded is provided adjacent to the A1 area. This area is called a “K area”. A decoding system will be described later on. Further, the A1 area and the K area will be collectively referred to as “meta-data”.

Title list information of all contents recorded on the magnetic tape 104 is recorded on the nonvolatile memory 102 and the A1 area. Since this information is text data, it can be recorded on the nonvolatile memory 102 and the A1 area. However, due to restrictions on the memory capacity, information accompanied with still images may not be recorded on the nonvolatile memory 102 and the A1 area. Accordingly, information accompanied with still images may be separately recorded on an A2 area and a Bn area which will be described later on.

A section S3 in which detailed information of all contents recorded on the magnetic tape 104 are recorded is provided adjacent to the K area. This section S3 is called an “A2 area”. The A2 area is the area from which data is first read out after management information was read out from the nonvolatile memory 102 or after backup data was read out from the A1 area in order to confirm detailed information of each of the contents. After data was read out from the A2 area, it is possible for a user to visually confirm detailed information of each of the contents. That is, thumbnail pictures, which are representing still pictures of all contents recorded on the magnetic tape 104, are recorded on the A2 area.

A section S4 in which thumbnail data in which chapters, scenes and the like used to search the contents are recorded at each of the contents are recorded is provided adjacent to the A2 area. This section S4 is called a “B1 area”. A position LBA (Logical Block Address) on the tape corresponding to the thumbnail is recorded on the A1 area. The LBA is one of addressing systems in a recording medium by which a user can designate a certain numeral to access a desired unit block by allocating numerals to respective unit blocks to be accessed in the sequential order of 0, for example. Then, a section S5 in which video data of contents are recorded is provided adjacent to the B1 area. This section S5 is called a “C1 area”. In this manner, the Bn area and the Cn area may make a pair. Similarly, a section S6 is called a “B2 area”, a section S7 is called a “C2 area”, a section S8 is called a “B3 area” and a section S9 is called a “C3 area”. That is, according to this embodiment, three contents are continuously recorded on the areas in the sequential order of B1, C1, B2, C2, B3, C3 areas. Then, the A2 area and Bn area will be collectively referred to as “still picture data” and the Cn area will be referred to as “moving picture data”.

The data in the Bn area is retained in the disc memory 41 as a file when contents of the corresponding Cn area are read. Therefore, during the contents are being reproduced, chapters and scenes of the contents can be searched at any time. When other contents are selected next, information of the Bn area corresponding to the contents is read out and the file on the disc memory 41 may be overwritten.

Next, the data structure of groups will be described with reference to an example of a data structure of groups of FIG. 6C. Each of the aforementioned sections S1 to S9 is always composed of more than one group. From the example of the data structure of the sections shown in FIG. 6B and the C1 area (section S5) by way of example, it is to be understood that eight groups from groups G1 to G8 are recorded on the C1 area. The block which is the minimum unit to record data retains the area of 512 bytes per block and 1565 blocks, not shown, are recorded on each group in the non-compressed state. Data which might be called a “file mark” indicative of the end of section is recorded on the end of the section. However, 1565 blocks need not always be recorded on the group on which the file mark is recorded. That is, a file mark F5 is recorded on the group G8 and contents data recorded on the group G8 need not always reach 1565 blocks, which may be permitted in the AIT format. It is natural that each of other groups G1 to G7 should be composed of 1565 blocks. The blocks are recorded on the groups so as not to straddle the boundary between the groups. The value of 1565 blocks is an optimum value obtained when the AIT1 format tape is available and hence this value of blocks may be changed when an AIT2 format tape or an AIT3 format tape is available.

Also, each group includes an ID (identification) information segment in which tape format management data is recorded in addition to user data. In the example of the data structure of the groups shown in FIG. 6C, ID information is filled into a space between user data of the groups G1 to G8 and thereby ID information is written in a multiplexed fashion. File marks and file mark counts, which will be described later on, are recorded on the ID information segment.

Referring back to the example of the data structure of the sections shown in FIG. 6B, with respect to all of the sections S1 to S9, file marks F1 to F9 indicative of the end of each section are recorded on the ID information segments of all groups in the form of a file mark count which is a numeral obtained by accumulating file marks from the beginning of the section at every partition to the target group.

In this case, let us consider the partition P2 by way of example. As shown in FIG. 6B, file mark counts are recorded on the ID information segments existing in the groups G1 to G8 within the C1 area, respectively. Herein, “4” which is a numeral obtained by accumulating the file marks of the sections S1 to S4 is recorded as the file mark count of the groups G1 to G8. Then, since the file mark is recorded on the group G8, the file mark count recorded on the ID information segment of the group G8 is calculated as “4”, since the file mark is recorded on the group G8, the file mark count recorded on the ID information segment of the group G8 is calculated as 4+1=“5”. The thus recorded file mark count is used in “retrying control” which will be described later on.

In this manner, since the file mark counts are recorded on the ID information segments of all groups in a multiplexed fashion, when the contents are searched at a high speed, the target file mark count can be detected reliably and hence it becomes possible to access the target contents.

In this embodiment, the number of contents contained in the magnetic tape 104 is set to 100 contents at most. Then, one of the contents contains one corresponding B area and one corresponding C area. Assuming now that the magnetic tape 104 contains only one partition, then it is to be understood that when 100 contents are recorded on this partition, the sections are arranged in the order of the A1 area, the K area, the A2 area, the B1 area, the C1 area, the B2 area, the C2 area, . . . , the B100 area, the C100 area and that the number of file marks is counted as 100×2+3=203.

Herein, the manner to decode contents will be described. Decoding keys of all contents recorded on the partition are recorded on the aforementioned K area. Then, one decoding key is used at each of the contents. Three contents are recorded on the partition P2 which is shown in the example of the data structure of the sections shown in FIG. 6B, by way of example, and hence three decoding keys are recorded on the K area.

During the contents are being reproduced, if performance of the tape reproducing apparatus 1 is lowered when encrypted data is decoded, then a transfer rate of reproduced data is lowered and there is a possibility that reproduction of contents will be too late for a real time. In this embodiment, all blocks may not be encrypted but they may be encrypted intermittently in order to prevent the performance of the tape reproducing apparatus 1 from being lowered. For example, blocks may be encrypted at every block. Then, it is possible to adjust a transfer rate to reproduce the contents by adjusting a space between the encrypted blocks. A space between the encrypted blocks is recorded on the A1 area.

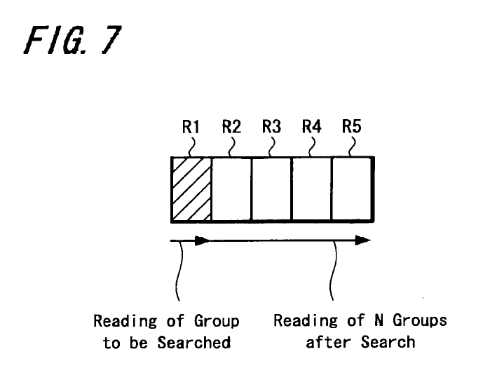

FIG. 7 is an explanatory diagram showing examples of read groups when contents are searched in the tape reproducing apparatus 1 according to this embodiment.

When a certain group is read, in order to maintain a transfer rate at which reproduced data is outputted to an output unit, reproduced data is temporarily accumulated in the buffer memory 20 shown in FIG. 2. The buffer memory 20 has limitations on its storage capacity to accumulate therein reproduced data, and an amount of reproduced data accumulated in the buffer memory 20 may be set by a transfer rate or a storage capacity of the buffer memory 20 itself and so forth.

Herein, search operations required when a user intends to view new contents will be described. First, a list of images of contents is displayed on the chapter picture and a user designates desired contents. The user is able to designate the desired contents by operating the keys on the remote controller or the keys on the front panel 7 of the tape reproducing apparatus 1. When a certain contents is designated, the starting portion of the contents is searched by transporting the magnetic tape 104 in the forward direction or the opposite direction based on an address recorded on the RAM 45. After the search of the starting portion of the contents was completed, in order to display new contents, reproduced data of the preceding contents accumulated in the buffer memory 20 are erased from the buffer memory 20 and the buffer memory 20 becomes empty.

In general, when the contents are continuously reproduced, it is determined based on an amount of reproduced data accumulated in the buffer memory 20 whether or not retrying should be executed. That is, retrying should be made only when reproduction of a moving picture is not interrupted. The reason for this is that, even when data may not be obtained due to a read error, if data accumulated beforehand in the buffer memory 20 is read out from the buffer memory 20, then reproduction of a moving picture can be prevented from being affected by the read error. A reference value of an amount of data accumulated in this buffer memory 20 is determined based on an average transfer rate of reproduced data to be handled. When reproduced data is transmitted at an average transfer rate of 10 Mbps, for example, moving picture data of 10/8=1.25 MB is read out from the buffer memory 20 per second. If it takes 2.4 seconds on the average to execute one retrying, then 1.25×2.4=3 MB can be determined as a reference value. Thus, when data greater than this reference value are accumulated in the buffer memory 20, retrying can be carried out.

Since the buffer memory 20 is empty as mentioned beforehand immediately after the starting portion of the contents was searched, it is clear that the amount of data accumulated in the buffer memory 20 should become less than 3 MB of the reference value. As a result, under the aforementioned conditions, the tape reproducing apparatus 1 becomes unable to carry out retrying. To avoid this state, data should be accumulated in the buffer memory 20 in the state in which retrying can be carried out half forcibly up to the constant number (Y times). To this end, a standby time of a predetermined duration is provided in a time period during which contents are read out and reproduced images are displayed after the starting portion of the target contents was searched. That is, a time period during which retrying can be made Y times is set. For example, in order that retrying may be executed only once (Y=1), the number of groups equivalent to the aforementioned 3 MB is designated. Specifically, since one group is approximately 800 KB, 3/0.8=3.75 groups. Thus, if only 4 groups are read out after search, then moving picture data greater than the reference value can be accumulated in the buffer memory 20. Herein, if the number of groups read out after search is N, then it is sufficient that this N should be set to “4”.

In this embodiment, as shown in FIG. 7, the group to be read when the starting portion of the target contents is searched is a search group R1. Then, since the aforementioned number of groups to be read after search is “4”, data from search groups R2 to R5 are read out within a standby time lasting until reproduced images are displayed. After reproduced data of the 4 groups were accumulated in the buffer memory 20, display of reproduced images is started and then continuous reproduction of reproduced images may be carried out.

Next, processing for discriminating the kind of data in the tape reproducing apparatus 1 according to this embodiment will be described. This discrimination processing is carried out by the system processing unit 15 which is one of the control means, for example. The kind of data may be discriminated by using the value of the aforementioned file mark count. When the kind of data is discriminated as described above, it becomes possible to set the retrying limit number at every kind of data.

If the file mark count obtained when the preceding group is read is “0”, then the group that is now being read is the A1 area. Alternatively, when the group is read out from the starting area of the tape, the group that is now being read is the A1 area. Also, if the file mark count obtained when the preceding group is read is “1”, then the group that is now being read is the K area. That is, the kind of data can be determined as meta-data.

If the file mark count obtained when the preceding group is read is “2”, then the group that is now being read is the A2 area. If the file mark count obtained when the preceding group is read is “odd number greater than 3”, then the group that is now being read is the B area. That is, the kind of data can be determined as still picture data.

If the file mark count obtained when the preceding group is read is “even number greater than 4”, then the group that is now being read is the C area. That is, the kind of data can be determined as moving picture data.

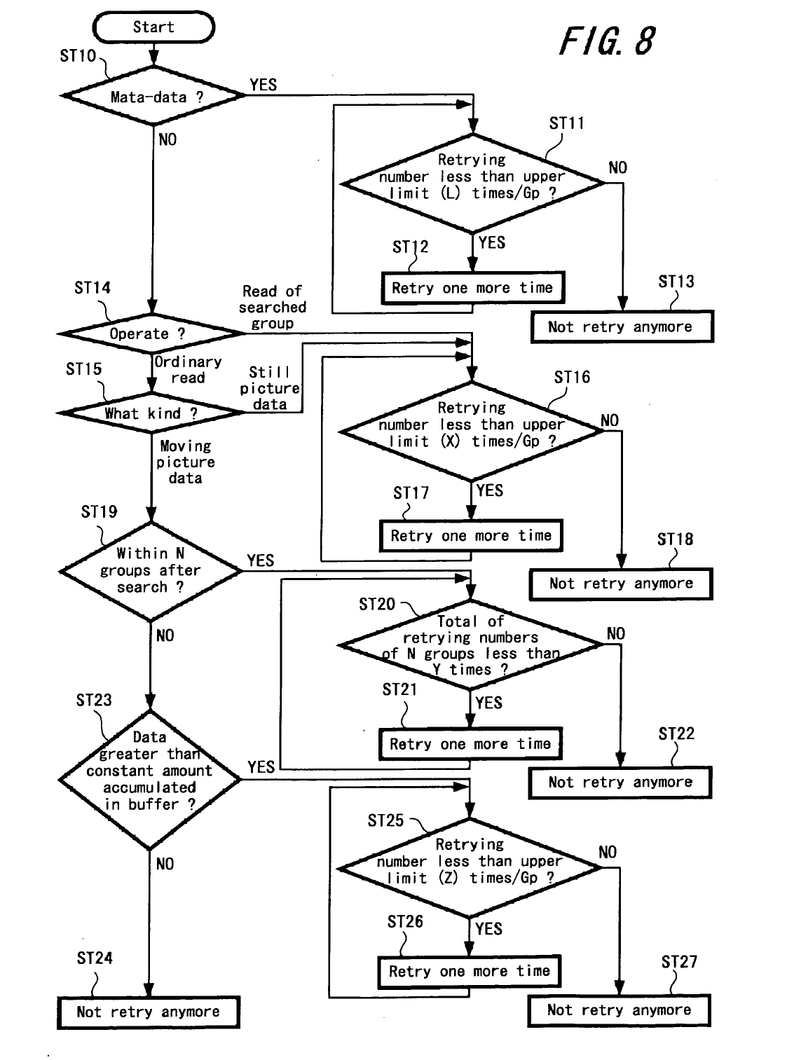

FIG. 8 is a flowchart to which reference will be made in explaining a retrying control procedure executed under control of the system processing unit 15 in the tape reproducing apparatus 1 according to this embodiment. Next, an example of a retrying control procedure will be described with reference to the flowchart of FIG. 8.

Herein, upper limit numbers L, X, Y and Z set a value of retrying of meta-data, a value of retrying of still picture and searched group, a value of retrying of moving picture within searched N groups and a value of retrying based on a value of the buffer memory 20.

Referring to FIG. 8, and following the start of the retrying control procedure, it is determined at a decision step ST10 whether or not read data is meta-data. If the read data is not meta-data as represented by a NO at the decision step ST10, then control goes to a step ST14. If on the other hand read data is meta-data as represented by a YES at the decision step ST10, then control goes to the next decision step ST11. It is determined at the decision step ST11 whether the number of retrying thus made so far is less than the upper limit retrying number L per group or greater than the upper limit retrying number L. If the retrying number is less than the upper limit retrying number L per group as represented by a YES at the decision step ST11, then control goes to a step ST12, whereat retrying is made one more time. If on the other hand the retrying number is greater than the upper limit retrying number L per group as represented by a NO at the decision step ST11, then control goes to a step ST13, whereat retrying is abandoned and it is determined that data may not be obtained.

If read data is not meta-data as represented by a NO at the decision step ST10, then control goes to the next decision step ST14. It is determined at the decision step ST14 whether the reading is reading of the searched group or ordinary reading. If it is determined that the reading is the reading of the searched group, then control goes to a step ST16. If it is determined that the reading is the ordinary reading for continuous reproduction, then control goes to the next decision step ST15, whereat it is determined whether the read image data is still picture data or moving picture data. If it is determined that the read image data is the moving picture data, then control goes to the next decision step ST19. If it is determined that the read image data is the still picture data, then control goes to the next decision step ST16. In the decisions step ST16, it is determined whether the retrying number thus made so far is less than the upper limit retrying number X per group or greater than the upper limit retrying number X. If the above-mentioned retrying number is less than the upper limit retrying number X per group as represented by a YES at the decision step ST16, then control goes to a step ST17, whereat retrying is made one more time. If the above-mentioned retrying number is greater than the upper limit retrying number X per group, then control goes to a step ST18, whereat retrying is ended. Then, the thus read data is reproduced as it is regardless of whether or not the thus read data is correct data.

If it is determined at the decision step ST15 that the read image is the moving picture, then control goes to the decision step ST19, whereat it is determined whether or not reproduction is reproduction within the N groups after search. If the reproduction is not the reproduction within the N groups after search as represented by a NO at the decision step ST19, then control goes to the next decisions step ST23. If on the other hand the reproduction is the reproduction within the N groups after search as represented by a YES at the decision step ST19, then control goes to the next decisions step ST20, whereat it is determined whether the sum total of retrying numbers of the N groups is less than the previously-determined upper limit retrying number Y or greater than the upper limit retrying number Y. If the above sum total of retrying numbers is less than the upper limit retrying number Y as represented by a YES at the decision step ST20, then control goes to a step ST21, whereat retrying is made one more time. If on the other hand the above sum total of retrying number is greater than the upper limit retrying number Y as represented by a NO at the decision step ST20, then control goes to a step ST22, whereat retrying is ended. Then, the thus read data is reproduced as it is regardless of whether or not the thus read data is correct data.

If the reproduction is not the reproduction within the N groups after search as represented by a NO at the decision step ST19, then control goes to the next decision step ST23, whereat it is determined whether or not the moving image data greater than a constant amount is accumulated in the buffer memory 20. If the moving image data greater than the constant amount is not accumulated in the buffer memory 20 as represented by a NO at the decision step ST23, then control goes to a step ST24, whereat retrying is made no more. If on the other hand the moving image data greater than the constant amount is accumulated in the buffer memory 20 as represented by a YES at the decision step ST23, then control goes to the next decision step ST25. In the decision step ST24, it is determined whether the retrying number made so far is less than or greater than the previously-determined upper limit retrying number Z per group. If the above retrying number is less than the upper limit retrying number Z as represented by a YES at the decision step ST23, then control goes to a step ST24, whereat retrying is made no more. If on the other hand the above retrying number is greater than the upper limit retrying number Z as represented by a NO at the decision step ST25, then control goes to a step ST27, whereat retrying is ended. Then, the thus read data is reproduced as it is regardless of whether or not the thus read data is correct data.

As described above, since the retrying upper limit number can be set at every kind of data such as the meta-data, the still picture data and the moving picture data, it is possible to reproduce contents in which the retrying number is limited in response to significance of data. For example, retrying of meta-data can be set as L=16 (times), retrying of still picture and searched group can be set as X=1 (time), retrying of moving picture within searched W group can be set as Y=1 (time) and retrying of moving picture in which case the data greater than the constant amount is accumulated in the buffer memory 20 can be set as Z=1 (time). Also, N=4 (groups) can be set as the range of the searched N groups. These values are those which may be set freely in accordance with the data transfer rate or the storage capacity of the buffer memory 20 and they are not limited to the above-mentioned numerical values.

Also, by retrying moving picture data only when data greater than the reference value is stored in the buffer memory 20, even if the thus read moving picture data may not be correctly recognized due to errors, then moving picture data can be read out from the buffer memory 20 during data is being reread so that the moving picture can be smoothly reproduced without interruption.

Alternatively, when other contents are viewed from some contents, the group is searched in order to detect the starting portion of the contents. It is possible to reproduce data, which may be correct to some extent, by executing retrying within the predetermined retrying number.

Then, if a standby time of a constant duration is provided after the search of the group in order to detect the starting portion of the contents and retrying is made during that time period, then reproduced data of target contents can be accumulated in the buffer memory 20 which was made empty by discarding the preceding contents data. In this manner, since reproduced data greater than the constant amount is accumulated in the buffer memory 20, even when a read error occurs, the tape reproducing apparatus can be set in the state in which retrying can be made and hence the moving picture can be reproduced smoothly.

Further, while the tape unit 5 and the CPU 40 are connected in communication through the SCSI interface 24 in the above-mentioned embodiment, the present invention is not limited thereto and they may be communicated with each other by using the inexpensive IDE interface, which can provide high-speed data communication, through the IDE bus in a two-way communication fashion. In the present invention, devices may be connected together by using a cable including a high-speed interface other than those described in the above-mentioned embodiment.

Furthermore, while the present invention has been explained so far by using the example of the tape streamer using the 8-mm tape cassette in the above-mentioned embodiment, the present invention is not limited thereto and the present invention can be applied to tape streamers of various forms to record digital data.

According to the present invention, since the kind of data can be discriminated and read, it is possible to control the retrying number in response to the kind of data. For example, it is possible to smoothly carry out retrying corresponding to the object of data reproduction by effecting control on the retrying in such a manner that important meta-data should be retried many times, still picture data, which is not limited from a time standpoint, should be retried a certain number of times and that moving picture data of which continuity is regarded as important should be retried a few times.

Also, if the retrying number of the meta-data is set to be greater than the retrying number of the still picture data which is not so much limited from a time standpoint and the retrying number of the moving picture data of which continuity is regarded as important, then there can be achieved an effect in which important information can be obtained reliably when data is reproduced.

Further, even if a read error occurs when data greater than the reference value is accumulated in the buffer memory during a moving picture is being reproduced, then retrying of the moving picture data can be carried out without interrupting the continuity of the moving picture. Also, even when data less than the reference value are accumulated in the buffer memory, it is possible to reliably reproduce data by retrying the data within the predetermined retrying number of times.

Furthermore, if a standby time of a constant duration is provided after the section of the still picture data or the moving picture data was searched and retrying within the predetermined number is carried out, reproduced data can be accumulated in the empty buffer memory so that the moving picture can be reproduced smoothly. Also, even when a read error occurs, moving picture data can be retried without interrupting continuity of the moving picture.

It should be understood by those skilled in the art that various modifications, combinations, sub-combinations and alterations may occur depending on design requirements and other factors insofar as they are within the scope of the appended claims or the equivalents thereof.

What is claimed is:

1. A tape reproducing apparatus for reproducing a magnetic tape in which each content is recorded by dividing into a plurality of partition units, said partition is divided into a plurality of section units at every meta-data, still picture data and moving picture data, and in which file marks indicative and assigned for ends of each sections, and a file mark count obtained by accumulatively adding said file marks at every section are recorded, comprising:
data read means for reading said magnetic tape;
data discriminating means for discriminating the kind of meta-data, still picture data and moving picture data by using said file mark count obtained by reading said magnetic tape with said data read means; and
control means for controlling retrying processing to read the same portion of said magnetic tape by said data read means if data read by said data read means may not be error-corrected and setting the upper limit number of retrying processing to read the same portion of said magnetic tape at every kind of meta-data, still picture data and moving picture data discriminated by said data discriminating means.

2. A tape reproducing apparatus according to claim 1, wherein said control means sets the upper limit number of retrying processing to read an interval discriminated as meta-data to be greater than the upper limit numbers of retrying processing to read still picture data and moving picture data.

3. A tape reproducing apparatus according to claim 1, further comprising a buffer memory for temporarily storing therein data obtained when said magnetic tape is read by said data read means and wherein said control means executes said retry processing to read a section in which moving picture data is recorded within the upper limit number set for moving picture data if an amount of data accumulated in said buffer memory is greater than a predetermined value, said control means limiting said retrying processing to the number less than said upper limit number set to said moving picture data if an amount of data accumulated in said buffer memory is not greater than said predetermined value.

4. A tape reproducing apparatus according to claim 1, wherein said control means limits retrying processing to the number less than the upper limit number set for still picture data and moving picture data during a predetermined period in which said data read means starts reading data from the searched tape position after said data read means has searched a section in which still picture data is recorded or a section in which moving picture data is recorded.
